(19) United States
(12) Patent Application Publication
(10) Pub. No.: US 2008/0148749 A1
(43) Pub. Date: Jun. 26, 2008

(54) Air Conditioning Control System and Air Conditioning Control Device

(75) Inventor: Koichi Ishida, Osaka (JP)

Correspondence Address: GLOBAL IP COUNSELORS, LLP, 1233 20TH STREET, NW, SUITE 700, WASHINGTON, DC, 20036-2680, US

(73) Assignee: Daikin Industries, Ltd., Osaka-shi,Osaka (JP)

(21) Appl. No.: 11/884,145

(22) PCT Filed: Feb. 21, 2006
(86) PCT No.: PCT/JP06/03046

§ 371 Date: Aug. 10, 2007

(30) Foreign Application Priority Data
Feb. 25, 2005 (JP) 2005-050811

(51) Int. Cl. G05D 23/32; H01H 43/00

(52) U.S. Cl. 62/157; 700/306

(57) ABSTRACT

An air conditioning control system includes an air conditioner, an operating capacity setting unit, an operating capacity range changing unit, a first authentication information inputting unit, and an operating capacity range change allowability determining unit. With the operating capacity setting unit, the operating capacity of the air conditioner can be set within a first range. With the operating capacity range changing means, the first range can be changed to a second range. With the first authentication information inputting unit, a first authentication information can be input. The operating capacity range change allowability determining unit determines whether or not to allow a change from the first range to the second range based on the first authentication information.

### CROSS-REFERENCE TO RELATED APPLICATIONS

This U.S. National stage application claims priority under 35 U.S.C. §119(a) to Japanese Patent Application No. 2005-050811, filed in Japan on Feb. 25, 2005, the entire contents of which are hereby incorporated herein by reference.

### TECHNICAL FIELD

The present invention relates to an air conditioning control system and an air conditioning control device to which authentication technologies are applied.

### BACKGROUND ART

In the past, an invention was disclosed which provides “a remote controller which allows the operation of an air conditioner only when preset identification information matches input identification information” (for example, see Patent Document 1). According to this invention, it is possible to prohibit a person other than a specific user from performing remote control operation. A regulated air conditioning control can be achieved, for example, at places such as school.

<Patent Document 1>

Japanese Published Patent Application No. 2002-033328

### DISCLOSURE OF THE INVENTION

### Problem to be Solved by the Invention

In recent years, there are cases, for example, where children and/or elderly family members and the like having decreased sensation to temperature operate an air conditioner by a remote controller without a permission of a householder and the like and cause the room to be overcooled or overheated. This could result in problems such as children, elderly people, and the like easily catching a cold or the householder and the like being charged with unexpected expenses. Such problems can be easily solved by the householder and the like prohibiting children, elderly people, and the like from operating an air conditioner by the remote controller according to the above described invention, however, it may cause stress to children, elderly people, and the like. An object of the present invention is to provide an air conditioning control system capable of preventing: children, elderly people, and the like from easily catching a cold; the householder and the like from being charged with unexpected expenses; and children, elderly people, and the like from experiencing excessive stress.

### Means to Solve the Problem

An air conditioning control system according to a first aspect of the present invention comprises an air conditioner, an operating capacity setting means, an operating capacity range changing means, a first authentication information inputting means, and an operating capacity range change allowability determining means. Note that these means may be provided to the air conditioner or to an air conditioning control device such as a remote controller. Or, these means may be provided separately, i.e., some to the air conditioner and others to the air conditioning control device. With the operating capacity setting means, the operating capacity of the air conditioner can be set within a first range. With the operating capacity range changing means, the first range can be changed to a second range. Note that the “second range” used herein is a range that is within the first range and narrower than the first range. In addition, the second range may be specified in advance or may be set on a timely basis. In addition, the “range” used herein refers to, for example, temperature setting range, air volume setting range, humidity setting range, and operating hours setting range. With the first authentication information inputting means, a first authentication information can be input. Note that the “first authentication information” used herein refers to, for example, password, identification number, image, and biological information (sound, fingerprint, voiceprint, palm print, iris, etc.). The operating capacity range change allowability determining means determines whether or not to allow a change from the first range to the second range based on the first authentication information. Note that, in the case where the second range can be set on a timely basis, the operating capacity range change allowability determining means may determine whether or not to allow the range change after the second range is input, or may display a second range input screen after whether or not to allow the range change is determined.

In this air conditioning control system, with the operating capacity setting means, the operating capacity of the air conditioner can be set within the first range. In addition, with the operating capacity range changing means, the first range can be changed to the second range. Further, with the first authentication information inputting means, the first authentication information can be input. In addition, the operating capacity range change allowability determining means determines whether or not to allow a change from the first range to the second range based on the first authentication information. Therefore, in this air conditioning control system, if only the householder and the like know the first authentication information, the householder and the like can allow children, elderly people, and the like to use the air conditioner only within the second range. Therefore, in this air conditioning control system, the householder and the like can prevent children, elderly people, and the like from operating the air conditioner and causing the room to be overcooled or overheated. As a result, in this air conditioning control system, the householder and the like can prevent children, elderly people, and the like from easily catching a cold and the householder and the like from being charged with unexpected expenses. In addition, in this air conditioning control system, the householder and the like can set the second range in a manner that prevents children, elderly people, and the like from experiencing excessive stress. As a result, this air conditioning control system can prevent: children, elderly people, and the like from easily catching a cold; the householder and the like from being charged with unexpected expenses; and children, elderly people, and the like from experiencing excessive stress.

An air conditioning control system according to a second aspect of the present invention is the air conditioning control system according to the first aspect of the present invention, further comprising a first authentication information setting means. With the first authentication information setting means, the first authentication information can be set. The operating capacity range change allowability determining means allows a change from the first range to the second range only when the first authentication information set with the first authentication information setting means matches the first authentication information input with the first authentication information inputting means.

In this air conditioning control system, with the first authentication information setting means, the first authentication information can be set. Further, the operating capacity range change allowability determining means allows a change from the first range to the second range only when the first authentication information set with the first authentication information setting means matches the first authentication information input with the first authentication information inputting means. Accordingly, in this air conditioning control system, the householder and the like can arbitrarily select the first authentication information. Therefore, in this air conditioning control system, the level of security with respect to the range change can be improved.

An air conditioning control system according to a third aspect of the present invention is the air conditioning control system according to the second aspect of the present invention, further comprising an information displaying means. The operating capacity range change allowability determining means displays, on the information displaying means, a second range setting screen which enables the second range to be set, only when the first authentication information set with the first authentication information setting means matches the first authentication information input with the first authentication information inputting means.

In this air conditioning control system, the operating capacity range change allowability determining means displays, on the information displaying means, a second range setting screen which enables the second range to be set, only when the first authentication information set with the first authentication information setting means matches the first authentication information input with the first authentication information inputting means. Accordingly, in this air conditioning control system, whether or not to allow the range change is determined before the second range is set. Therefore, in this air conditioning control system, it is possible to save the time of the user (for example, the householder and the like) in changing the range.

A air conditioning control system according to a fourth aspect of the present invention is the air conditioning control system according any one of the first aspect through the third aspect of the present invention, further comprising an operating capacity range restoring means. With the operating capacity range restoring means, the second range can be changed back to the first range.

In this air conditioning control system, with the operating capacity range restoring means, the second range can be changed back to the first range. Accordingly, in this air conditioning control system, the user (for example, the householder and the like) can handle the range change in a flexible manner.

An air conditioning control system according to a fifth aspect of the present invention is the air conditioning control system according to the fourth aspect of the present invention, further comprising an operating capacity range restoration allowability determining means. The operating capacity range restoration allowability determining means determines whether or not to allow a change from the second range back to the first range, based on the second authentication information. Note that the “second authentication information” used herein refers to, for example, password, identification number, image, and biological information (sound, fingerprint, voiceprint, palm print, iris, etc.). In addition, the second authentication information may be the same as the first authentication information.

In this air conditioning control system, the operating capacity range restoration allowability determining means determines whether or not to allow a change from the second range back to the first range, based on the second authentication information. Accordingly, in this air conditioning control system, it is possible to increase the level of security with respect to the range change by a third person (for example, a child, elderly person, etc.).

An air conditioning control system according to a sixth aspect of the present invention is the air conditioning control system according to any one of the first aspect through the fifth aspect of the present invention, further comprising a second range effective period setting means. With the second range effective period setting means, an effective period of the second range can be set. Note that it may be designed such that fundamentally the first range is applied in a period outside of the effective period of the second range, however, it may be designed such that the first range can be limited to a predetermined operating capacity value within the first range in a period outside of the effective period of the second range. In addition, the “period” used herein is specified by week, date, time, day of the week, etc.

In this air conditioning control system, with the second range effective period setting means an effective period of the second range can be set. Accordingly, in this air conditioning control system, it is possible to save the time of the householder and the like in changing the second range back to the first range.

An air conditioning control system according to a seventh aspect of the present invention is the air conditioning control system according to the sixth aspect of the present invention, wherein, with the second range effective period setting means, a plurality of effective periods of the second range can be set.

In this air conditioning control system, with the second range effective period setting means, a plurality of effective periods of the second range can be set. Accordingly, in this air conditioning control system, the householder and the like can set effective periods of the second range in a very precise manner.

An air conditioning control system according to an eighth aspect of the present invention is the air conditioning control system according to the sixth aspect or the seventh aspect of the present invention, further comprising a first operating capacity value limiting means. With the first operating capacity value limiting means, the first range can be limited to a predetermined operating capacity value within the first range in a period outside of the effective period of the second range. Note that the “operating capacity value” used herein may be a default value or a set value.

In this air conditioning control system, with the operating capacity value limiting means, the first range can be limited to a predetermined operating capacity value within the first range in a period outside of the effective period of the second range. Accordingly, in this air conditioning control system, the householder and the like can impose stricter restrictions on children and/or elderly people according to need.

An air conditioning control system according to a ninth aspect of the present invention is the air conditioning control system according to any one of the first aspect through the fifth aspect of the present invention, further comprising a 24-hour time limited effective range time inputting means and a 24-hour time limited effective range setting means. With the 24-hour time limited effective range time inputting means, a start time and an end time of an effective period of the first range or the second range can be set within a limited period of 24 hours. With the 24-hour time limited effective range setting means, when a start time and an end time of an effective period of the first range are input with the 24-hour time limited effective range time inputting means, a period from 0 hours to the start time and a period from the end time to 24 hours are set as effective periods of the second range. In addition, with this 24-hour time limited effective range setting means, when a start time and an end time of an effective period of the second range are input with the 24-hour time limited effective range time inputting means, a period from 0 hours to the start time and a period from the end time to 24 hours are set as effective periods of the first range.

In this air conditioning control system, when a start time and an end time of an effective period of the first range are input with the 24-hour time limited effective range time inputting means, a period from 0 hours to the start time and a period from the end time to 24 hours are set as effective periods of the second range, with this 24-hour time limited effective range setting means. In addition, when a start time and an end time of an effective period of the second range are input with the 24-hour time limited effective range time inputting means, a period from 0 hours to the start time and a period from the end time to 24 hours are set as effective periods of the first range, with this 24-hour time limited effective range setting means. Accordingly, in this air conditioning control system, the householder and the like can freely set effective periods of the first range and the second range with a simple remote control operation.

An air conditioning control system according to a tenth aspect of the present invention is the air conditioning control system according to any one of the first aspect through the fifth aspect of the present invention, further comprising a 24-hour time limited multiple effective range time inputting means and a 24-hour time limited multiple effective range setting means. With the 24-hour time limited multiple effective range time inputting means, a plurality of effective periods of the first range or a plurality of effective periods of the second range can be set within a limited period of 24 hours. With the 24-hour time limited multiple effective range setting means, when a plurality of effective periods of the first range are input with the 24-hour time limited multiple effective range time inputting means, a period outside of the effective periods of the first range is set as an effective period of the second range; when a plurality of effective periods of the second range are input with the 24-hour time limited multiple effective range time inputting means, a period outside of the effective periods of the second range is set as an effective period of the first range.

In this air conditioning control system, when a plurality of effective periods of the first range are input with the 24-hour time limited multiple effective range time inputting means, a period outside of the effective periods of the first range is set as an effective period of the second range, with the 24-hour time limited multiple effective range setting means. In addition, when a plurality of effective periods of the second range are input with the 24-hour time limited multiple effective range time inputting means, a period outside of the effective periods of the second range is set as an effective period of the first range, with the 24-hour time limited multiple effective range setting means. Accordingly, in this air conditioning control system, with a simple remote control operation, the householder and the like can freely set effective periods of the first range and the second range, and set effective periods of the first range or the second range in a very precise manner.

An air conditioning control system according to an eleventh aspect of the present invention is the air conditioning control system according to the ninth aspect or the tenth aspect of the present invention, further comprising a second operating capacity value limiting means. With the second operating capacity value limiting means, the first range can be limited to a predetermined operating capacity value within the first range.

In this air conditioning control system, with the second operating capacity value limiting means, the first range can be limited to a predetermined operating capacity value within the first range. Accordingly, in this air conditioning control system, the householder and the like can impose stricter restrictions on children and/or elderly people according to need.

An air conditioning control system according to a twelfth aspect of the present invention is the air conditioning control system according to any one of the ninth aspect through the eleventh aspect of the present invention, further comprising a day of the week inputting means. With the day of the week inputting means, days of the week to set an effective period can be input.

In this air conditioning control system, with the day of the week inputting means, days of the week to set an effective period can be input. Accordingly, in this air conditioning control system, convenience for the householder and the like can be further improved.

An air conditioning control system according to a thirteenth aspect of the present invention is the air conditioning control system according to the first aspect of the present invention, further comprising an air conditioning control device. The air conditioning control device is provided separately from the air conditioner. In addition, the operating capacity setting means, the operating capacity range changing means, the authentication information inputting means, and the operating capacity range change allowability determining means are disposed in the air conditioning control device. Note that the air conditioner and the air conditioning control device may be connected via a communication wire or via wireless.

In this air conditioning control system, the air conditioning control device is provided separately from the air conditioner. In addition, the operating capacity setting means, the operating capacity range changing means, the authentication information inputting means, and the operating capacity range change allowability determining means are disposed in the air conditioning control device. Accordingly, a supplier of the air conditioning control system can sell the air conditioning control device by itself to the existing user.

An air conditioning control system according to a fourteenth aspect of the present invention is the air conditioning control system according to the first aspect of the present invention, further comprising an air conditioning control device. The air conditioning control device is provided separately from the air conditioner. The operating capacity setting means, the operating capacity range changing means, and the authentication information inputting means are disposed in the air conditioning control device. In addition, the operating capacity range change allowability determining means is disposed in the air conditioner. Note that the air conditioner and the air conditioning control device may be connected via a communication wire or via wireless.

In this air conditioning control system, the air conditioning control device is provided separately from the air conditioner. The operating capacity setting means, the operating capacity range changing means, and the authentication information inputting means are disposed in the air conditioning control device. In addition, the operating capacity range change allowability determining means is disposed in the air conditioner. Accordingly, in this air conditioning control system, the structure of the air conditioning control device can be simplified.

An air conditioning control system according to a fifteenth aspect of the present invention is the air conditioning control system according to the thirteenth aspect or the fourteenth aspect of the present invention, wherein the air conditioner and the air conditioning control device are connected via wireless. Note that “wireless connection” used herein includes, for example, infrared ray connection.

In this air conditioning control system, the air conditioner and the air conditioning control device are connected via wireless. Accordingly, in this air conditioning control system, convenience for the user (such as the householder, children, elderly people, etc.) can be improved.

An air conditioning control device according to a sixteenth aspect of the present invention comprises an operating capacity setting means, an operating capacity range changing means, a first authentication information inputting means, and an operating capacity range change allowability determining means. With the operating capacity setting means, the operating capacity of the air conditioner can be set within a first range. With the operating capacity range changing means, the first range can be changed to a second range. Note that the “second range” used herein is a range within the first range and narrower than the first range. With the first authentication information inputting means, a first authentication information can be input. The operating capacity range change allowability determining means determines whether or not to allow a change from the first range to the second range based on the first authentication information.

In this air conditioning control device, with the operating capacity setting means, the operating capacity of the air conditioner can be set within the first range. In addition, with the operating capacity range changing means, the first range can be changed to the second range. Further, with the first authentication information inputting means, the first authentication information can be input. In addition, the operating capacity range change allowability determining means determines whether or not to allow a change from the first range to the second range based on the first authentication information. Therefore, if only the householder and the like know the first authentication information, the householder and the like can allow children, elderly people, and the like to use the air conditioner only within the second range. Therefore, the householder and the like can prevent children, elderly people, and the like from operating the air conditioner and causing the room to be overcooled or overheated. As a result, the householder and the like can prevent children, elderly people, and the like from easily catching a cold and the householder and the like from being charged with unexpected expenses. In addition, the householder and the like can set the second range in a manner that prevents children, elderly people, and the like from experiencing excessive stress. As a result, the householder and the like can prevent: children, elderly people, and the like from easily catching a cold; the householder and the like from being charged with unexpected expenses; and children, elderly people, and the like from experiencing excessive stress.

An air conditioning control system according to a seventeenth aspect of the present invention comprises an air conditioner, a function activation selecting means, a first authentication information inputting means, and a function selection allowability determining means. The air conditioner has a plurality of functions. Note that the “functions” used herein refers to, for example, cooling function, heating function, dehumidifying function, ventilation function, and fan function. With the function activation selecting means, it is possible to select whether or not to activate each of the plurality of functions. Note that a default pattern of function activation may be provided. In addition, when a default pattern exists, a means to return to the default pattern may be further provided. With the first authentication information inputting means, a first authentication information can be input. The function selection allowability determining means determines whether or not to allow the selection based on the first authentication information.

In this air conditioning control system, the air conditioner has a plurality of functions. With the function activation selecting means, it is possible to select whether or not to activate each of the plurality of functions. In addition, with the first authentication information inputting means, the first authentication information can be input. The function selection allowability determining means determines whether or not to allow the selection based on the first authentication information. Therefore, in this air conditioning control system, if only the householder and the like know the first authentication information, the householder and the like can allow children, elderly people, and the like to use only specific functions. Therefore, in this air conditioning control system, if, for example, the householder and the like disable a powerful cooling (or heating) function or the like and enable a normal cooing (or heating) function or the like, the householder and the like can prevent children, elderly people, and the like from operating the air conditioner and causing the room to be overcooled or overheated. As a result, in this air conditioning control system, the householder and the like can prevent children, elderly people, and the like from easily catching a cold and the householder and the like from being charged with unexpected expenses. In addition, in this air conditioning control system, the householder and the like can select functions in a manner that prevents children, elderly people, and the like from experiencing excessive stress. As a result, this air conditioning control system can prevent: children, elderly people, and the like from easily catching a cold; the householder and the like from being charged with unexpected expenses; and children, elderly people, and the like from experiencing excessive stress.

An air conditioning control device according to an eighteenth aspect of the present invention comprises a function activation selecting means, a first authentication information inputting means, and a function selection allowability determining means. With the function activation selecting means, it is possible to select whether or not to activate each of a plurality of functions of an air conditioner. With the first authentication information inputting means, a first authentication information can be input. The function selection allowability determining means determines whether or not to allow the selection based on the first authentication information.

In this air conditioning control device, with the function activation selecting means, it is possible to select whether or not to activate each of the plurality of functions of the air conditioner. In addition, with the first authentication information inputting means, the first authentication information can be input. Further, the function selection allowability determining means determines whether or not to allow the selection based on the first authentication information. Therefore, if only the householder and the like know the first authentication information, the householder and the like can allow children, elderly people, and the like to use only specific functions of the air conditioner. Therefore, if, for example, the householder and the like disable a powerful cooling (or heating) function or the like and enable a normal cooing (or heating) function or the like, the householder and the like can prevent children, elderly people, and the like from operating the air conditioner and causing the room to be overcooled or overheated. As a result, the householder and the like can prevent children, elderly people, and the like from easily catching a cold and the householder and the like from being charged with unexpected expenses. In addition, the householder and the like can select functions in a manner that prevents children, elderly people, and the like from experiencing excessive stress. As a result, the householder and the like can prevent: children, elderly people, and the like from easily catching a cold; the householder and the like from being charged with unexpected expenses; and children, elderly people, and the like from experiencing excessive stress.

### Effects of the Present Invention

In the air conditioning control system according to the first aspect of the present invention, if only the householder and the like know the first authentication information, the householder and the like can allow children, elderly people, and the like to use the air conditioner only within the second range. Therefore, in this air conditioning control system, the householder and the like can prevent children, elderly people, and the like from operating the air conditioner and causing the room to be overcooled or overheated. As a result, in this air conditioning control system, the householder and the like can prevent children, elderly people, and the like from easily catching a cold and the householder and the like from being charged with unexpected expenses. In addition, in this air conditioning control system, the householder and the like can set the second range in a manner that prevents children, elderly people, and the like from experiencing excessive stress. As a result, this air conditioning control system can prevent: children, elderly people, and the like from easily catching a cold; the householder and the like from being charged with unexpected expenses; and children, elderly people, and the like from experiencing excessive stress.

In the air conditioning control system according to the second aspect of the present invention, the householder and the like can select the first authentication information. Therefore, in this air conditioning control system, the level of security with respect to the range change can be improved.

In the air conditioning control system according to the third aspect of the present invention, whether or not to allow the range change is determined before the second range is set. Therefore, in this air conditioning control system, it is possible to save the time of the user (for example, the householder and the like) in changing the range.

In the air conditioning control system according to the fourth aspect of the present invention, the user (for example, the householder and the like) can handle the range change according to circumstances.

In the air conditioning control system according to the fifth aspect of the present invention, it is possible to increase the level of security with respect to the range change by a third person (for example, a child, elderly person, etc.).

In the air conditioning control system according to the sixth aspect of the present invention, it is possible to save the time of the householder and the like in changing the second range back to the first range.

In the air conditioning control system according to the seventh aspect of the present invention, the householder and the like can set an effective period of the second range in a very precise manner.

In the air conditioning control system according to the eighth aspect of the present invention, the householder and the like can impose stricter restrictions on children and/or elderly people according to need.

In the air conditioning control system according to the ninth aspect of the present invention, the user can freely set an effective period of the first range and the second range with a simple remote control operation.

In the air conditioning control system according to the tenth aspect of the present invention, with a simple remote control operation, the householder and the like can freely set effective periods of the first range and the second range, and set effective periods of the first range or the second range in a very precise manner.

In the air conditioning control system according to an eleventh aspect of the present invention, the householder and the like can impose stricter restrictions on children, elderly people, and the like according to need.

In the air conditioning control system according to the twelfth aspect of the present invention, convenience for the user can be further improved.

A supplier of the air conditioning control system according to the thirteenth aspect of the present invention can sell the air conditioning control device by itself to an existing user.

In the air conditioning control system according to the fourteenth aspect of the present invention, the structure of the air conditioning control device can be simplified.

In the air conditioning control system according to the fifteenth aspect of the present invention, convenience for the user (such as the householder, children, elderly people, etc.) can be improved.

The air conditioning control device according to the sixteenth aspect of the present invention enables the householder and the like to allow children, elderly people, and the like to use the air conditioner only within the second range, provided that the first authentication information is given only to the householder and the like. Therefore, the householder and the like can prevent children, elderly people, and the like from operating the air conditioner and causing the room to be overcooled or overheated. As a result, the householder and the like can prevent children, elderly people, and the like from easily catching a cold and the householder and the like from being charged with unexpected expenses. In addition, the householder and the like can set the second range in a manner that prevents children, elderly people, and the like from experiencing excessive stress. As a result, the householder and the like can prevent: children, elderly people, and the like from easily catching a cold; the householder and the like from being charged with unexpected expenses; and children, elderly people, and the like from experiencing excessive stress.

In the air conditioning control system according to the seventeenth aspect of the present invention, if only the householder and the like know the first authentication information, the householder and the like can allow children, elderly people, and the like to use only specific functions. Therefore, in this air conditioning control system, if, for example, the householder and the like disable a powerful cooling (or heating) function or the like and enable a normal cooing (or heating) function or the like, the householder and the like can prevent children, elderly people, and the like from operating the air conditioner and causing the room to be overcooled or overheated. As a result, in this air conditioning control system, the householder and the like can prevent children, elderly people, and the like from easily catching a cold and the householder and the like from being charged with unexpected expenses. In addition, in this air conditioning control system, the householder and the like can select functions in a manner that prevents children, elderly people, and the like from experiencing excessive stress. As a result, this air conditioning control system can prevent: children, elderly people, and the like from easily catching a cold; the householder and the like from being charged with unexpected expenses; and children, elderly people, and the like from experiencing excessive stress.

With the air conditioning control device according to the eighteenth aspect of the present invention, the householder and the like can allow children, elderly people, and the like to use only specific functions, provided that the first authentication information is given only to the householder and the like. Therefore, if, for example, the householder and the like disable a powerful cooling (or heating) function or the like and enable a normal cooing (or heating) function or the like, the householder and the like can prevent children, elderly people, and the like from operating the air conditioner and causing the room to be overcooled or overheated. As a result, the householder and the like can prevent children, elderly people, and the like from easily catching a cold and the householder and the like from being charged with unexpected expenses. In addition, the householder and the like can select functions in a manner that prevents children, elderly people, and the like from experiencing excessive stress. As a result, the householder and the like can prevent: children, elderly people, and the like from easily catching a cold; the householder and the like from being charged with unexpected expenses; and children, elderly people, and the like from experiencing excessive stress.

### BRIEF DESCRIPTION OF THE DRAWINGS

FIG. 1 is an external perspective view of an air conditioner according to the present invention.

FIG. 2 is a refrigerant circuit diagram of the air conditioner according to the present invention.

FIG. 3 is an exploded perspective view of an outdoor unit of the air conditioner according to the present invention.

FIG. 4 is a block diagram of a main body control unit disposed in an indoor unit of the air conditioner according to the present invention.

FIG. 5 is an elevation view of a remote controller of the air conditioner according to the present invention.

FIG. 6 is a control block diagram of the remote controller of the air conditioner according to the present invention.

FIG. 7 is a flowchart of a remote control operation of the air conditioner according to the present invention.

FIG. 8 is a flowchart of a control range change/function selection routine performed by the remote controller of the air conditioner according to the present invention.

FIG. 9 is a flowchart of a control range cancellation/default function restoration routine performed by the remote controller of the air conditioner according to the present invention.

FIG. 10 is a flowchart of a password check routine performed by the remote controller of the air conditioner according to the present invention.

### DESCRIPTION OF THE REFERENCE SYMBOLS

1 air conditioner
8 remote controller (air conditioning control device)
81 liquid crystal panel (information displaying means)
82f arrow buttons (first authentication information inputting means)
84 remote controller control unit (operating capacity setting means, operating capacity range changing means, operating capacity range change allowability determining means, first authentication information setting means, operating capacity range restoring means, operating capacity range restoration allowability determining means, function activation selecting means, function selection allowability determining means, range change period setting means)

### BEST MODE FOR CARRYING OUT THE INVENTION

### <Structure of the Air Conditioner>

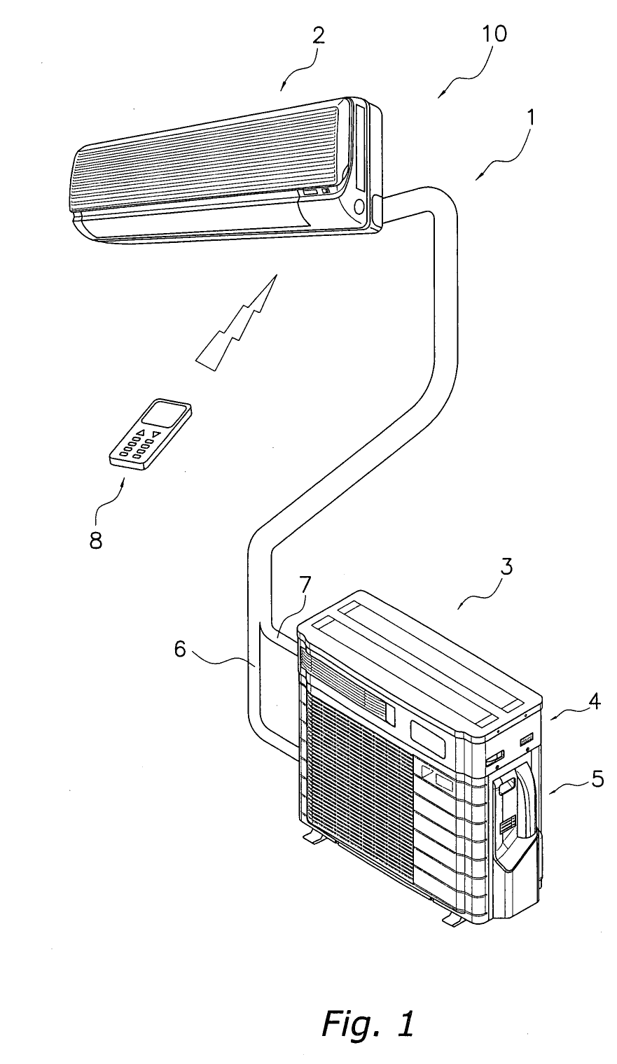

FIG. 1 shows an external view of an air conditioner 1 according to an embodiment of the present invention.

This air conditioner 1 comprises an indoor unit 2 attached to a wall or the like of a room and an outdoor unit 3 installed outside. The outdoor unit 3 includes an outdoor air conditioning unit 5 configured to house an outdoor heat exchanger, propeller fan, and the like, and a humidified air supply and exhaust unit 4. The indoor unit 2 houses an indoor heat exchanger therein, and the outdoor unit 3 houses the outdoor heat exchanger therein. Each of the heat exchangers and a refrigerant pipe 6 that connects these heat exchangers constitute a refrigerant circuit. In addition, disposed between the outdoor unit 3 and the indoor unit 2 is an air supply and exhaust pipe 7, which is used when outdoor air, humidified air, and the like are supplied from the humidified air supply and exhaust unit 4 to the indoor unit 2 side and indoor air is exhausted to the outside. Further, this air conditioner 1 is provided with a remote controller 8, and by using the remote controller 8, the user can arbitrarily adjust the operating capacity of the air conditioner 1 and use various functions installed in the air conditioner 1. Note that in this embodiment, the air conditioner 1 and the remote controller 8 are inclusively referred to as an air conditioning control system 10.

### <Structure of the Refrigerant Circuit>

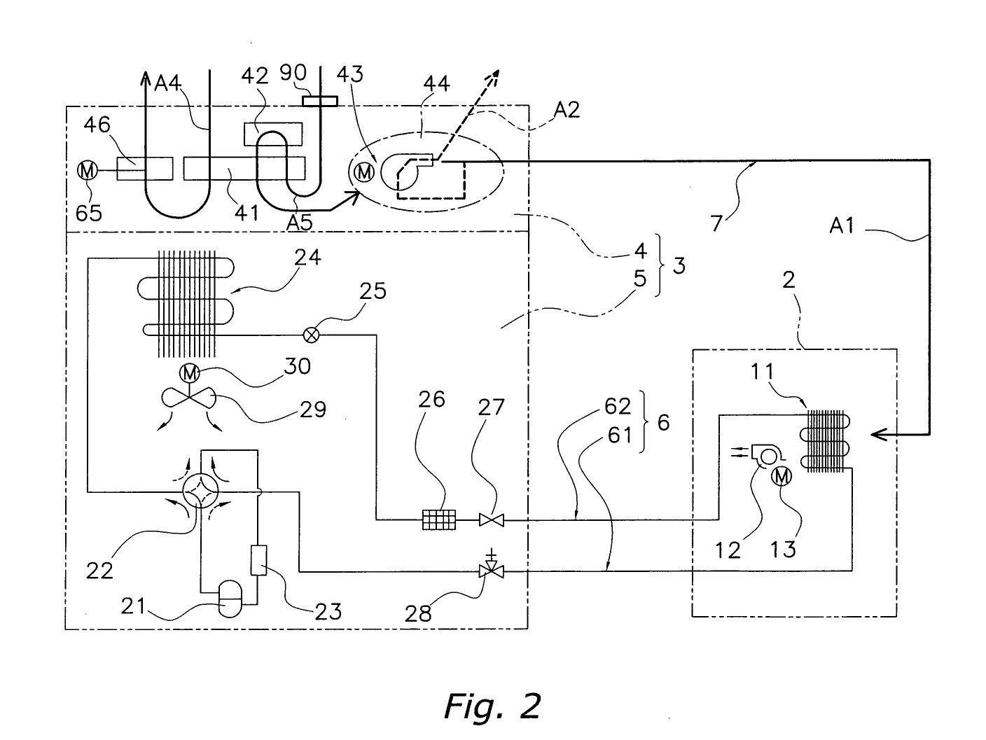

FIG. 2 is a view in which a schematic diagram of air flow is added to a system diagram of a refrigerant circuit used in the air conditioner 1.

The indoor unit 2 is provided with an indoor heat exchanger 11. This indoor heat exchanger 11 comprises a heat transfer tube which is folded back a plurality of times at longwise ends thereof, and a plurality of fins through which the heat transfer tube is inserted. The indoor heat exchanger 11 is configured to exchange heat with the air that comes into contact therewith.

Also disposed in the indoor unit 2 are a cross flow fan 12 and an indoor fan motor 13 configured to rotationally drive the cross flow fan 12. The cross flow fan 12 has a cylindrical structure with a number of vanes at its circumferential surface, and is configured to generate an air flow in a direction perpendicular to the rotational axis. This cross flow fan 12 causes indoor air to be sucked into the indoor unit 2 and causes air that has been subjected to heat exchange with the indoor heat exchanger 11 to be blown out into the room.

Disposed in the outdoor air conditioning unit 5 are a compressor 21, a four way switching valve 22 connected to a discharge side of the compressor 21, an accumulator 23 connected to the suction side of the compressor 21, an outdoor heat exchanger 24 connected to the four way switching valve 22, and a motor valve 25 connected to the outdoor heat exchanger 24. The motor valve 25 is connected to the refrigerant pipe 62 via a filter 26 and a liquid shut-off valve 27, and is connected to an end of the indoor heat exchanger 11 via the refrigerant pipe 62. In addition, the four way switching valve 22 is connected to the refrigerant pipe 61 via a gas shut-off valve 28 and is connected to the other end of the indoor heat exchanger 11 via the refrigerant pipe 61. These refrigerant pipes 61, 62 correspond to the refrigerant pipe 6 shown in FIG. 1, and together with the above described air supply and exhaust pipe 7, the refrigerant pipes 61, 62 constitute a collective connecting pipe.

Also disposed in the outdoor air conditioning unit 5 is a propeller fan 29 for exhausting air that has been subjected to heat exchange in the outdoor heat exchanger 24 to the outside. This propeller fan 29 is rotationally driven by an outdoor fan motor 30.

### <Structure of the Outdoor Unit>

As shown in FIG. 1, the outdoor unit 3 comprises the outdoor air conditioning unit 5 on the lower side and the humidified air supply and exhaust unit 4 on the upper side, which are integrated together.

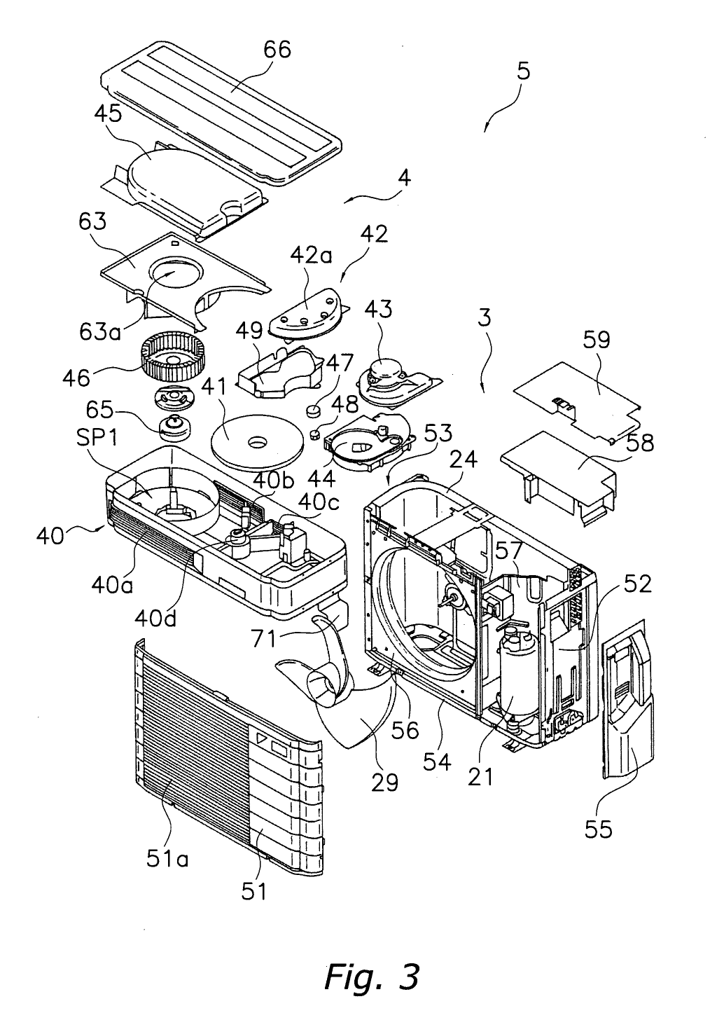

First, the structure of the outdoor air conditioning unit 5 is described with reference to FIG. 3.

### <Structure of the Outdoor Air Conditioning Unit>

The outdoor air conditioning unit 5 comprises casing members such as a the front panel 51, lateral plates 52, 53, a protection wire mesh (not shown), and a metallic bottom panel 54, and refrigerant circuit components housed therein, and the like.

The front panel 51 is a member made of resin which covers the front side of the outdoor air conditioning unit 5, and is disposed on the downstream side of air passing through the outdoor heat exchanger 24. Disposed in the front panel 51 is an outdoor air conditioning unit outlet port 51a comprising a plurality of slit shaped openings. The air that has passed through the outdoor heat exchanger 24 is blown out from the outdoor air conditioning unit 5 to the outside of the outdoor unit 3 via the outdoor air conditioning unit outlet port 51a. In addition, a fan discharge port member 56 and a partition plate 57 are attached behind the front panel 51.

The lateral plates 52, 53 comprise the right side panel 52 and the left side panel 53. These are metallic members that cover the lateral sides of the outdoor air conditioning unit 5. Here, the right side panel 52 and the left side panel 53 are disposed respectively on the right and on the left of the outdoor unit 3 when viewed from the front. Note that, each of the lateral plates 52, 53 is disposed substantially in parallel to a blowout direction of air which passes through the outdoor heat exchanger 24 and is blown out from the outdoor air conditioning unit outlet port 51a. In addition, the right side panel 52 has a shut-off valve cover 55 attached thereto, which is configured to protect the liquid shut-off valve 27 and the gas shut-off valve 28 (see FIG. 2).

The refrigerant circuit components include the outdoor heat exchanger 24, the compressor 21, the accumulator 23, the four way switching valve 22, the motor valve 25, and the like (see FIG. 2).

The outdoor heat exchanger 24 has a substantially L-shape when viewed in a plan view, and is disposed in front of the protection wire mesh that covers the back side of the outdoor air conditioning unit 5.

The outdoor fan motor 30 (see FIG. 2) and the propeller fan 29 are provided in a ventilation space provided between the partition plate 57 and the left side panel 53, in front of the outdoor heat exchanger 24. The outdoor fan motor 30 rotates the propeller fan 29. The propeller fan 29 causes air taken into the outdoor air conditioning unit 5 to be brought into contact with the outdoor heat exchanger 24 and exhausted from the outdoor air conditioning unit outlet port 51a in the direction forward of the front panel 51.

Other refrigerant circuit components such as the compressor 21, the accumulator 23, the four way switching valve 22, the motor valve 25, and the like are disposed in a machine chamber between the partition plate 57 and the right side panel 52.

In addition, an electrical component unit 58 is attached to the upper portion of the outdoor air conditioning unit 5. The electrical component unit 58 comprises an electrical component box and a printed circuit board on which circuit components for controlling each portion are mounted. A flameproof plate 59 is attached above the electrical component unit 58.

### <Structure of the Humidified Air Supply and Exhaust Unit>

Next, the structure of the humidified air supply and exhaust unit 4 is described mainly with reference to FIG. 3.

(Humidified Air Supply and Exhaust Unit Casing)

The humidified air supply and exhaust unit 4 has a humidified air supply and exhaust unit casing 40. The humidified air supply and exhaust unit casing 40 covers the front, back, and both lateral sides of the humidified air supply and exhaust unit 4, and is disposed in contact with the upper portion of the outdoor air conditioning unit 5.

An adsorption air outlet 40a comprising a plurality of slit shaped openings is disposed on the front side of the humidified air supply and exhaust unit casing 40. Air passes through the adsorption air outlet 40a and is blown out to the outside of the outdoor unit 3.

In addition, on the back side of the humidified air supply and exhaust unit casing 40, an adsorption air inlet port 40b and an air supply and exhaust port 40c are juxtaposed in the left-right direction. The adsorption air inlet port 40b is an opening through which passes air taken in from the outside for causing an adsorption and humidification rotor 41 to adsorb moisture. The air supply and exhaust port 40c is an opening through which passes air taken in to be sent to the indoor unit 2 or through which passes air taken in from the indoor unit 2 to be exhausted to the outside.

Note that a photocatalytic filter 90 is disposed in front of the air supply and exhaust port 40c (see FIG. 2). The photocatalytic filter 90 comprises fibers, and photocatalytic apatite is supported by the fibers.

In addition, the top of the humidified air supply and exhaust unit casing 40 is covered by a top panel 66.

In the humidified air supply and exhaust unit casing 40, on the right is a space for housing the adsorption and humidification rotor 41 and the like, and on the left is an adsorption fan housing space SP1 for housing an adsorption fan 46 and the like. Disposed inside the humidified air supply and exhaust unit casing 40 are the adsorption and humidification rotor 41, a heater assembly 42, a radial fan assembly 43, a switching damper 44, an adsorption-side duct 45, the adsorption fan 46, and the like.

(Adsorption and Humidification Rotor)

The adsorption and humidification rotor 41 is a honeycomb ceramic rotor having a substantially disk shape, and has a structure that allows air to easily pass therethrough. The adsorption and humidification rotor 41 is a rotor having a circular shape when viewed in a plan view and whose cross section taken along the horizontal plane has a fine honeycomb pattern. Air passes through a plurality of bore portions of the adsorption and humidification rotor 41, with each bore having a polygonal shape on the cross section.

The main portion of the adsorption and humidification rotor 41 is formed by calcination of adsorbent such as zeolite, silica gel, or alumina. The adsorbent such as zeolite and the like have a characteristic to adsorb moisture in the air that comes in contact therewith and desorb the adsorbed and contained moisture when heated.

The adsorption and humidification rotor 41 is rotatably supported by a support shaft 40d provided on the humidified air supply and exhaust unit casing 40 side via a rotor guide (not shown). Gear teeth are formed on the circumferential surface of the adsorption and humidification rotor 41, and these gear teeth mesh with those of a rotor drive gear 48 attached to a drive shaft of a the rotor drive motor 47.

(Heater Assembly)

The heater assembly 42 comprises a heater cover 42a and a heater main body (not shown) housed therein, and is configured to heat air taken in from the outside and sent to the adsorption and humidification rotor 41. In addition, the heater assembly 42 is disposed so as to cover a substantially half (right side half) of the top of the adsorption and humidification rotor 41. On the lower side of the heater assembly 42, an inlet port for sucking air and an exhaust port for exhausting air heated by the heater assembly 42 to the adsorption and humidification rotor 41 side are formed. The heater assembly 42 is attached above the adsorption and humidification rotor 41 via a heater support plate 49.

(Radial Fan Assembly)

The radial fan assembly 43 is disposed on the lateral side of the adsorption and humidification rotor 41, and includes a radial fan (not shown) and a radial fan motor (not shown) configured to rotate the radial fan. In addition, the radial fan assembly 43 shares a top cover (not shown) with the switching damper 44, and the top cover closes the bottom of the radial fan assembly 43. The top cover is provided with an air outlet port and an air inlet port. The air outlet port is an opening through which passes air sent from the radial fan assembly 43 into the switching damper 44. The air inlet port is an opening through which passes air sent from inside the switching damper 44 to the radial fan assembly 43. The radial fan assembly 43 generates a flow of air that reaches the room from the air supply and exhaust port 40c via the adsorption and humidification rotor 41 and the switching damper 44 and sends air taken in from the outside into the indoor unit 2. In addition, the radial fan assembly 43 can also exhaust air taken in from the indoor unit 2 to the outside. The radial fan assembly 43 alternates these operations as the switching damper 44 is switched.

When sending air taken in from the outside into the indoor unit 2, the radial fan assembly 43 causes air that has passed through the adsorption and humidification rotor 41 and descended from a front portion of the right substantially half portion of the adsorption and humidification rotor 41 to be sent to a supply and exhaust air duct 71 via the switching damper 44. The supply and exhaust air duct 71 is connected to the air supply and exhaust pipe 7 (see FIG. 1), and the radial fan assembly 43 supplies air to the indoor unit 2 via the supply and exhaust air duct 71 and the air supply and exhaust pipe 7.

When exhausting room air taken in from the indoor unit 2 to the outside, the radial fan assembly 43 causes air sent from the supply and exhaust air duct 71 to be exhausted to the outside from the air supply and exhaust port 40c disposed on the back side of the humidified air supply and exhaust unit casing 40.

(Switching Damper)

The switching damper 44 is a rotary airflow passage switching means disposed below the radial fan assembly 43 and is switched to first, second, and third modes.

In the first mode, air blown out from the radial fan assembly 43 passes through the air supply and exhaust pipe 7 via the supply and exhaust air duct 71 and is supplied to the indoor unit 2. Accordingly, in the first mode, air flows in the direction indicated by solid arrow A1 in FIG. 2, and humidified air or outdoor air passes through the air supply and exhaust pipe 7 and is supplied to the indoor unit 2.

In the second mode, air flows in the direction indicated by dashed arrow A2 in FIG. 2, and air that has passed through the air supply and exhaust pipe 7 and the supply and exhaust air duct 71 from the indoor unit 2 is exhausted from the radial fan assembly 43 to the outside via the air supply and exhaust port 40c.

In the third mode, a pathway that connects the switching damper 44 and the supply and exhaust air duct 71 is closed, and airflow between the outdoor unit 3 and the indoor unit 2 is cut off.

(Adsorption-Side Duct and Adsorption Fan)

The adsorption-side duct 45 covers a portion (a left substantially half portion) of the top of the adsorption and humidification rotor 41, where the heater assembly 42 is not located. Together with an adsorption-side bellmouth 63, which is described later, the adsorption-side duct 45 forms an airflow passage that leads from the top of the left half portion of the adsorption and humidification rotor 41 to the upper portion of the adsorption fan housing space SP1, which is described below.

The adsorption fan 46 housed in the adsorption fan housing space SP1 is a centrifugal fan which is rotated by an adsorption fan motor 65, and is configured to generate airflow that flows from the adsorption air inlet port 40b to an opening 63a via the adsorption and humidification rotor 41, by sucking air through the opening 63a of the adsorption-side bellmouth 63 disposed above the adsorption fan 46. The adsorption fan 46 causes dry air whose moisture was adsorbed when the air passed through the adsorption and humidification rotor 41 to be exhausted from the adsorption air outlet 40a in the direction forward of the humidified air supply and exhaust unit casing 40. The adsorption-side bellmouth 63 is provided at the upper portion of the adsorption fan housing space SP1, and is configured to play a role in guiding air that passes through an airflow passage formed by the adsorption-side duct 45 to the adsorption fan 46.

### <Operation and Contents of the Control of the Humidified Air Supply and Exhaust Unit>

In order to describe a flow of air in the air conditioner 1 according to this embodiment, the operation of the humidified air supply and exhaust unit 4 is described below. In addition, here, the contents of the control of the humidification operation and the like are described.

### <Operation of the Humidified Air Supply and Exhaust Unit>

When the humidification operation is performed in the air conditioner 1 according to this embodiment, the above described switching damper 44 is switched to the first mode. Below, the operation of the humidified air supply and exhaust unit 4 when performing the humidification operation and the air supply operation is described with reference to FIGS. 2 and 3.

The humidified air supply and exhaust unit 4 rotatably drives the adsorption fan 46 and thereby takes outdoor air from the adsorption air inlet port 40b into the humidified air supply and exhaust unit casing 40. The air that has entered into the humidified air supply and exhaust unit casing 40 passes through the left substantially half portion of the adsorption and humidification rotor 41, and is exhausted from the adsorption fan housing space SP1 in the direction forward of the outdoor unit 3 through the adsorption air outlet 40a, via an airflow passage formed by the adsorption-side duct 45 and the adsorption-side bellmouth 63, and the adsorption fan 46 (see arrow A4 in FIG. 2 and FIG. 3). When air taken from the outside into the humidified air supply and exhaust unit casing 40 passes through the left substantially half portion of the adsorption and humidification rotor 41, the adsorption and humidification rotor 41 adsorbs moisture contained in air.

The left substantially half portion of the adsorption and humidification rotor 41, which has adsorbed moisture in this adsorbing step, will become the right substantially half portion of the adsorption and humidification rotor 41 as the adsorption and humidification rotor 41 rotates. In other words, the adsorbed moisture moves to a portion where the adsorption and humidification rotor 41 is located below the heater assembly 42 as the adsorption and humidification rotor 41 rotates. Then, the moisture that has moved to the above mentioned portion is desorbed into the air generated by the radial fan assembly 43 by the heat from the heater assembly 42.

When the radial fan assembly 43 is driven, outdoor air is taken from the air supply and exhaust port 40c into the humidified air supply and exhaust unit casing 40. Then the air passes through the back of the right substantially half portion of the adsorption and humidification rotor 41 in a down to up direction, and is introduced into the heater assembly 42 from the inlet port on the lower side of the heater assembly 42. Then, the air that has entered into the heater assembly 42 is exhausted from the exhaust port on the lower side of the heater assembly 42, passes through the front of the right substantially half portion of the adsorption and humidification rotor 41 in a up to down direction, passes through the inside of the switching damper 44 from a lateral opening of the casing (not shown) of the switching damper 44, and reaches the radial fan assembly 43 (see arrow A5 in FIG. 2 and FIG. 3). Such airflow is generated by the radial fan assembly 43. The radial fan assembly 43 causes air that has passed through the adsorption and humidification rotor 41 and the switching damper 44 as described above to be sent to the indoor unit 2 via the switching damper 44, the supply and exhaust air duct 71, and the air supply and exhaust pipe 7. The air that is sent to the indoor unit 2 contains moisture that has been adsorbed in the adsorption and humidification rotor 41.

In this way, the air supplied from the humidified air supply and exhaust unit 4 to the indoor unit 2 is blown out into the room via the indoor heat exchanger 11. Note that the air conditioner 1 can be configured so as to perform only an air supply and ventilation operation in which outdoor air is taken in and sent to the indoor unit 2 without being humidified, by disabling the adsorption fan motor 65 and the heater assembly 42.

### <Control of the Humidified Air Supply and Exhaust Unit>

Next, the control of the humidified air supply and exhaust unit 4 by a main body control unit 100 (described later) is described. The contents of the control include: control at the time of the above described humidification operation and control regarding the air supply operation, the air exhaust operation, and the defrosting operation.

(Humidification Operation)

The main body control unit 100 performs the humidification operation when received a humidification command from the remote controller 8 and when determined that the humidification operation needs to be performed in response to a humidification automatic operation command from the remote controller 8. The humidification operation is often operated along with the heating operation. In the humidification operation, the rotor drive motor 47, a heater main body, a radial fan motor, and the adsorption fan motor 65 in the humidified air supply and exhaust unit 4 are driven. In the humidification operation, as described above, moisture contained in the air introduced into the humidified air supply and exhaust unit 4 from the outside by the rotation of the adsorption fan 46 is adsorbed in the adsorption and humidification rotor 41, and air heated by the heater main body is passed through the adsorption and humidification rotor 41 by the rotation of the radial fan, thereby supplying air that contains moisture desorbed from the adsorption and humidification rotor 41 to the indoor unit 2 via the air supply and exhaust pipe 7.

(Air Supply Operation and the Air Exhaust Operation)

The main body control unit 100 performs the air supply operation or the air exhaust operation when determined that the ventilation of the room is necessary. The air supply operation is an operation in which the humidified air supply and exhaust unit 4 takes in outdoor air and the outdoor air is supplied from the air supply and exhaust pipe 7 to the indoor unit 2. The air exhaust operation is an operation in which air in the air supply and exhaust pipe 7 is sucked by the radial fan assembly 43 of the humidified air supply and exhaust unit 4; in other words, indoor air is sucked into the air supply and exhaust pipe 7 via the indoor unit 2, and the air is exhausted to the outside of the outdoor unit 3 from the radial fan assembly 43. Flows of air in the air supply operation and in the air exhaust operation are as described in the above descriptions of the first mode and the second mode, along with the description of the detailed structure of the switching damper 44. During the air supply operation, the switching damper 44 is in the first mode, and therefore outdoor air is supplied to the indoor unit 2 through the air supply and exhaust pipe 7. On the other hand, during the air exhaust operation, the switching damper 44 is in the second mode, and air that has passed through the air supply and exhaust pipe 7 from the indoor unit 2 is exhausted to the outside of the unit through the lateral opening of the casing of the switching damper 44 from the air outlet port of the radial fan assembly 43. Note that during the air supply operation and the air exhaust operation, the adsorption fan 46 and the rotor drive motor 47 of the humidified air supply and exhaust unit 4 are not operated and only the radial fan is rotated.

In addition, when it is desired to take in fresh outdoor air and gently ventilate the air while conditioning the air, the air supply operation can be selected.

Note that when the operation of the air conditioner 1 is stopped, the main body control unit 100 sets the switching damper 44 in the third mode that is different from the first mode or the second mode described above. In the third mode, communication between the room and the outside is shut off.

### <Structure of the Indoor Unit>

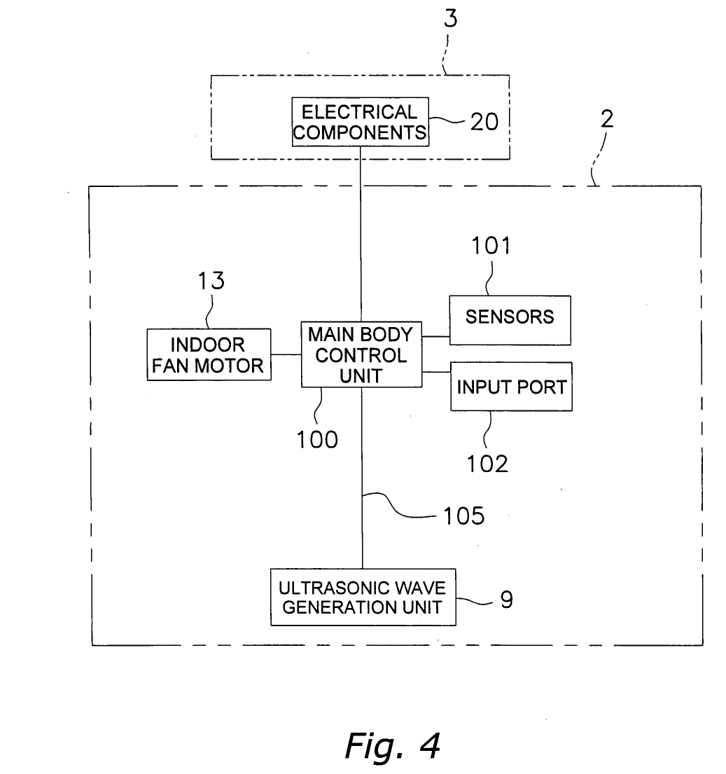

The indoor unit 2 comprises the main body control unit 100, sensors 101, an input port 102, an ultrasound wave generation unit 9, and the like, besides the above described components 11, 12, 13 (see FIG. 4). Specifically, the main body control unit 100 is a microcomputer or the like, and is connected to the indoor fan motor 13, various sensors 101 including a room temperature thermistor and the like, an electrical component 20 in an outdoor unit 2, the input port 102 that receives a signal from the remote controller 8, and the like via a first communication wire 105. The main body control unit 100 controls air conditioning functions such as cooling and heating, dehumidification, humidification, air supply and exhaust, and defrosting, and controls the ultrasound wave generation unit 9 and the like or the air conditioner 1.

### <Remote Controller>

The remote controller 8 sends a control signal to the air conditioner 1 and thereby adjusts the operating capacity of the air conditioner 1 and activates air conditioning functions of the air conditioner 1 such as cooling and heating, dehumidification, humidification, and the like and an ultrasound wave generation function of the ultrasound wave generation unit 9.

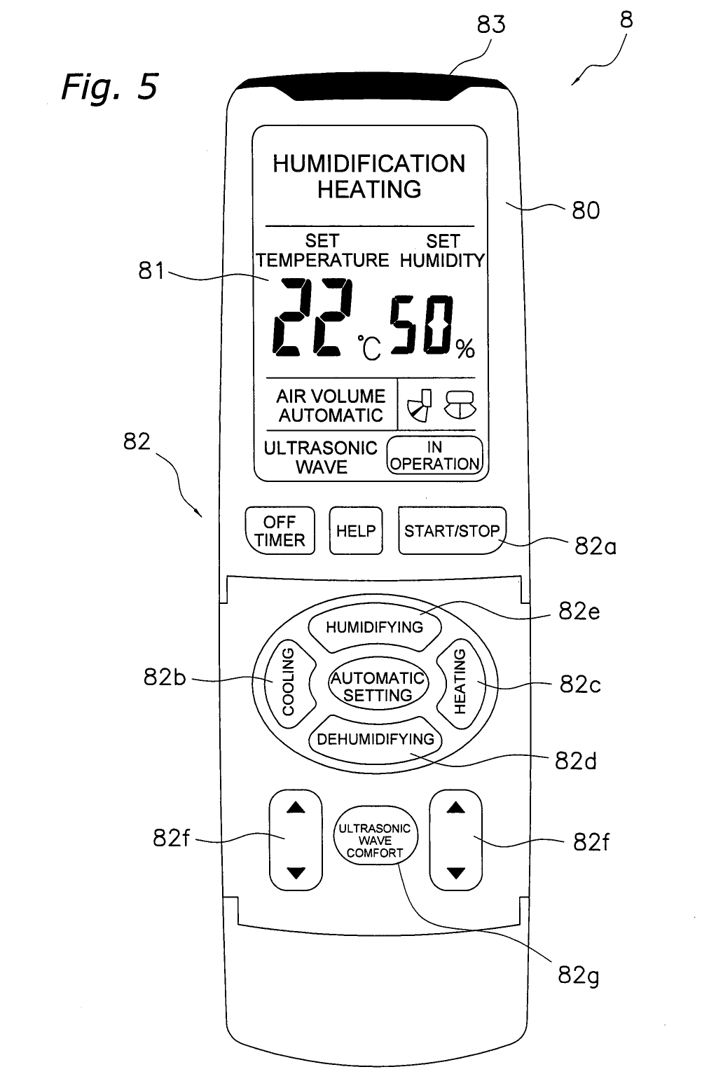

As shown in FIG. 5, the remote controller 8 comprises a remote controller main body 80, an output port 83, a liquid crystal panel 81, and operation buttons 82.

The output port 83 is disposed on the upper end of the remote controller main body 80 and configured to send a control signal to the input port 102 disposed in the air conditioner 1.

The liquid crystal panel 81 is disposed on the front side of the remote controller 8. The liquid crystal panel 81 displays a screen showing the contents of the operation and a screen for various settings such as set temperature, set humidity, air volume, setting of the ultrasound wave function, and the like.

The operation buttons 82 are disposed below the liquid crystal panel 81, on the front side of the remote controller 8. By pressing the operation buttons 82, a room occupant can select the contents of the control of the air conditioner 1 main body and the ultrasound wave generation unit 9. The operation buttons 82 include a start/stop button 82a, a cooling button 82b, a heating button 82c, a dehumidifying button 82d, a humidifying button 82e, arrow buttons 82f, and a comforting button 82g and the like. By pressing these buttons, the room occupant can operate various operations. For example, by pressing the start/stop button 82a, the user can easily select to start or stop the operation of the air conditioner 1. By pressing the cooling button 82b, the user can cause the air conditioner 1 to perform the cooling operation. In addition, by pressing the heating button 82c, the user can cause the air conditioner 1 to perform the heating operation. In addition, by pressing the dehumidifying button 82d, the user can cause the air conditioner 1 to perform the dehumidification operation. In addition, by pressing the humidifying button 82, the user can cause the air conditioner 1 to perform the humidification operation. In addition, by pressing the arrow button 82f, the user can adjust set temperature and set humidity. In addition, by pressing the comforting button 82g, the user can easily select to turn on or off the generation of a comforting ultrasound wave.

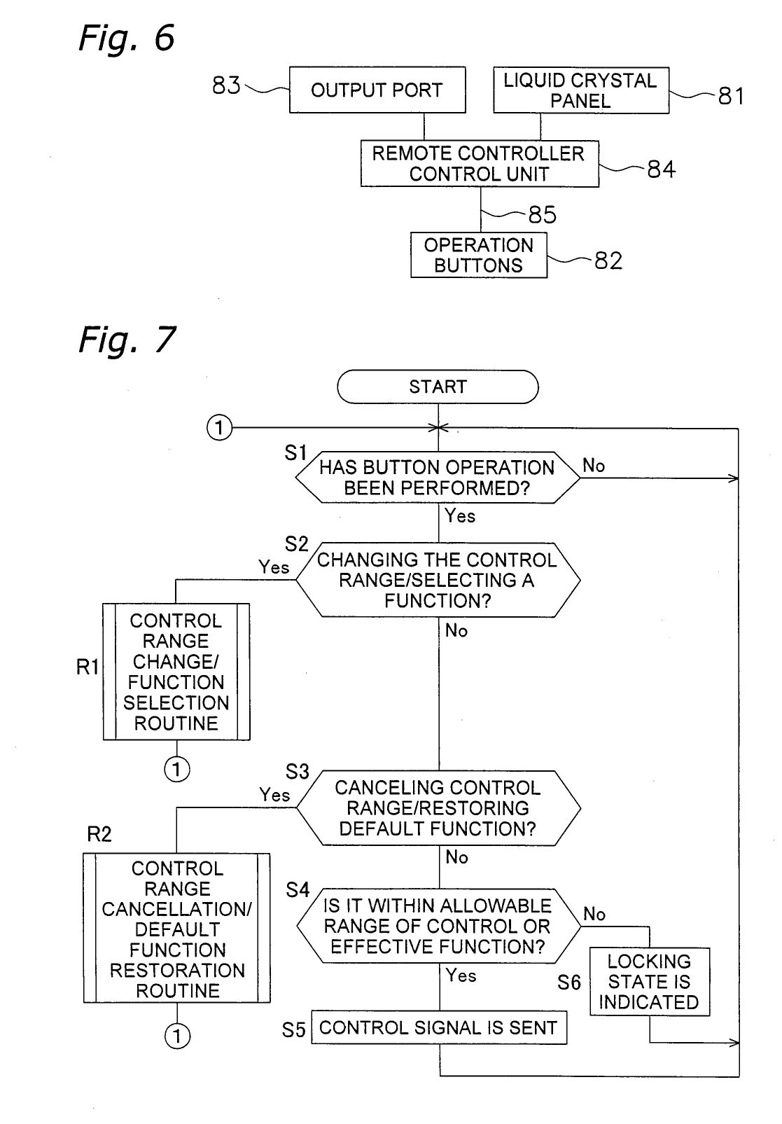

Note that, as shown in FIG. 6, the output port 83, the liquid crystal panel 81, and the operation buttons 82 of the remote controller 8 are connected to a remote controller control unit 84 housed in the remote controller main body 80 via a second communication wire 85. The remote controller control unit 84 interprets a command sent as the operation buttons 82 are pressed, displays information corresponding to the command on the liquid crystal panel 81, and sends a control signal corresponding to the command to the input port 102 of the air conditioner 1 via the output port 83.

In addition, by employing a touch panel type liquid crystal panel, various operations may be operated by pressing buttons that appear on the liquid crystal panel instead of pressing the operation buttons 82.

In addition, the remote controller 8 has an operation limiting function in which the user can limit the range to be operated and functions to be selected by a third person. Below, the operation limiting function is described with reference to flowcharts shown in FIGS. 7 to 10.

### <Operation Limiting Function>

(Main Processing)

In FIG. 7, in Step S1, the remote controller control unit 84 determines whether or not the user has performed a button operation. If a result of the determination by the remote controller control unit 84 in Step S1 indicates that the user has performed a button operation, the process proceeds to Step S2. If a result of the determination by the remote controller control unit 84 in Step S1 indicates that the user did not perform a button operation, the process returns to Step S1. In Step S2, the remote controller control unit 84 determines whether or not the button operation by the user is a button operation for changing the control range/selecting a function. Note that, here, the button operation for changing the control range/selecting a function refers to, for example, an operation in which the cooling button 82b is pressed while the comforting button 82g is pressed. If a result of the determination by the remote controller control unit 84 in Step S2 indicates that the button operation by the user is the button operation for changing the control range/selecting a function, the process proceeds to a control range change/function selection routine R1. If a result of the determination by the remote controller control unit 84 in Step S2 indicates that the button operation by the user is not the button operation for changing the control range/selecting a function, the process proceeds to Step S3. In Step S3, the remote controller control unit 84 determines whether or not the button operation by the user is a button operation for canceling the control range/restoring default function. Note that, here, the button operation for canceling the control range/restoring default function refers to, for example, an operation in which the heating button 82c is pressed while the comforting button 82g is pressed. In addition, here, “default” refers to a state in which all the functions provided to the remote controller 80 are enabled. If a result of the determination by the remote controller control unit 84 in Step S3 indicates that the button operation by the user is the button operation for canceling the control range/restoring default function, the process proceeds to a control range cancellation/default function restoration routine R2. If a result of the determination by the remote controller control unit 84 in Step S3 indicates that the button operation is not the button operation for canceling the control range/restoring default function, the process proceeds to Step S4. In Step S4, the remote controller control unit 84 determines whether or not the button operation by the user is the button operation within an allowable range of control or whether or not the button operation by the user corresponds to a function that is enabled. If a result of the determination by the remote controller control unit 84 in Step S4 indicates that the button operation by the user is a button operation within the allowable range of control or the button operation by the user corresponds to a function that is enabled, the process proceeds to Step S5. If a result of the determination by the remote controller control unit 84 in Step S4 indicates that the button operation by the user is a button operation out of the allowable range of control or the button operation by the user corresponds to a function that is disabled, the process proceeds to Step S6. In Step S5, the remote controller control unit 84 sends a control signal (remote control code) corresponding to the button operation to the input port 102 of the air conditioner 1 via the output port 83. In Step S6, the remote controller control unit 84 indicates or illuminates letters that say “control range is locked” or “function is locked” on the liquid crystal panel 81. Note that when the process in Step S5 or Step S6 is terminated, the process returns to Step S1.

(Control Range Change/Function Selection Routine)

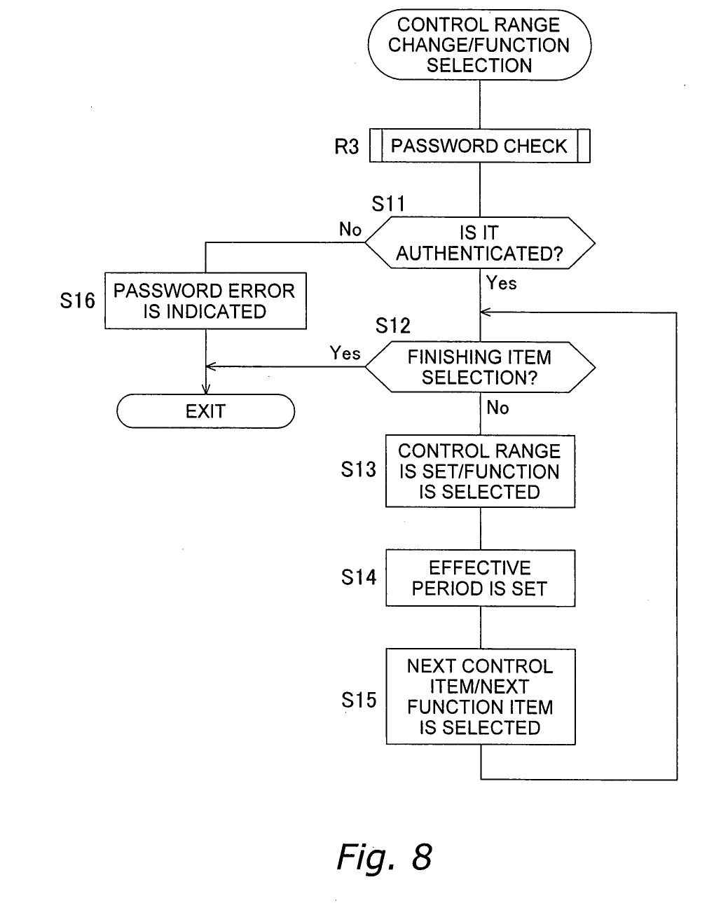

As shown in FIG. 8, in a password check routine R3, the remote controller control unit 84 performs a password checking process (the password checking process will be described in detail later). In Step S11, the remote controller control unit 84 determines whether or not a password is authenticated in the password check routine R3. If a result of the determination by the remote controller control unit 84 in Step S11 indicates that the password is authenticated in the password check routine R3, the process proceeds to Step S12. If a result of the determination by the remote controller control unit 84 in Step S11 indicates that the password is denied in the password check routine R3, the process proceeds to Step S16. In Step S12, the remote controller control unit 84 determines whether or not the user has finished selecting an item. If a result of the determination by the remote controller control unit 84 in Step S12 indicates that the user has finished selecting an item, the process is terminated. If a result of the determination by the remote controller control unit 84 in Step S12 indicates that the user has not finished selecting an item, the process proceeds to Step S13. In Step S13, the user sets the control range or selects a function of the selected item. Note that, here, the control range that can be set by the user is a range within a default control range and narrower than the default control range. In addition, here, the control range that can be set refers to temperature setting range, air volume setting range, humidity setting range, and sleep timer setting range. In addition, here, functions that can be selected includes cooling function, heating function, humidifying function, dehumidifying function, blower function, powerful cooling function, powerful heating function, and ultrasound wave generation function (start/stop function is excluded from the options). Further, control range setting and function selection are performed mainly by operating the arrow button 82f. In addition, such control range setting and function selection are reflected on a default operation performed by using a switch disposed on the indoor unit 2 side. In Step S14, the user sets an effective period of the control range that is set and the function that is selected. Note that, here, the user can register a single or a plurality of effective periods using days and hours. However, here, if the user does not input an effective period, an effective period will not be set (in other words, the control range that is set and the function that is selected will be effective until the battery of the remote controller 8 is exhausted). In addition, the user can register a periodic effective period using days of the week. In Step S15, the user selects a next control item or a next function item. Note that the selection of the next control item and the next function item is performed mainly by operating the cooling button 82b and the heating button 82c. In addition, when the process in Step S15 is terminated, the process returns to Step S12. In Step S16, the remote controller control unit 84 indicates or illuminates letters that say “password error” on the liquid crystal panel 81.

(Control Range Cancellation/Default Function Restoration Routine)

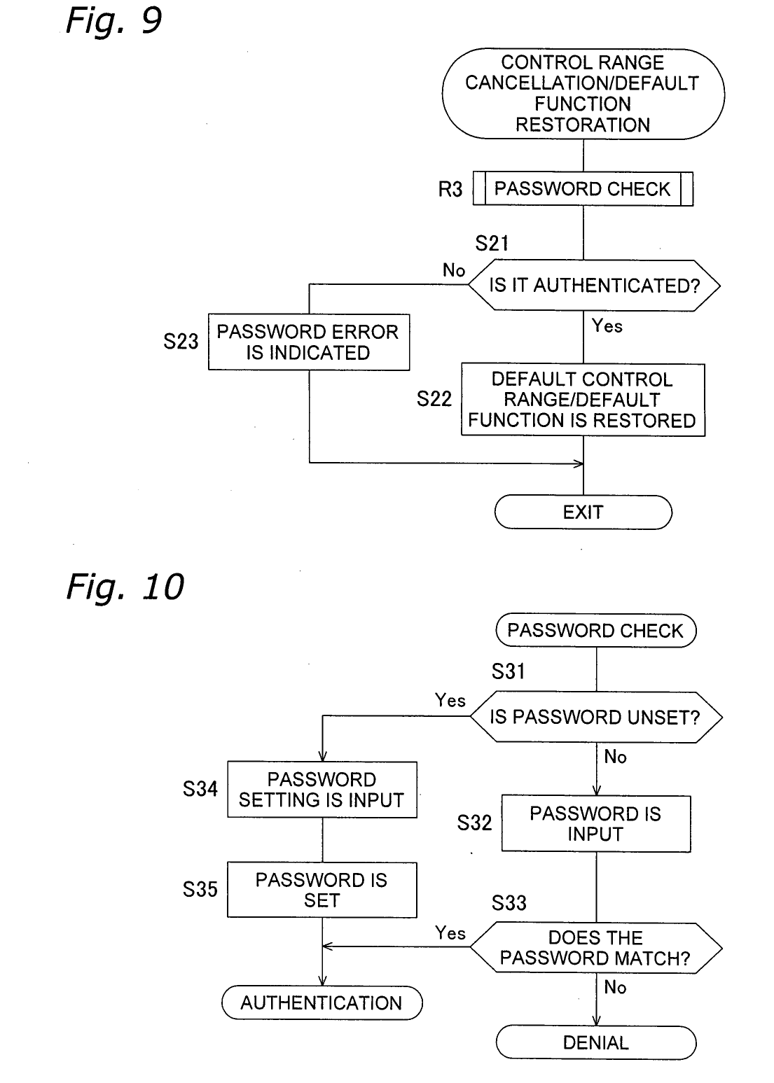

As shown in FIG. 9, in the password check routine R3, the remote controller control unit 84 performs a password checking process (the password checking process will be described in detail later). In Step S21, the remote controller control unit 84 determines whether or not a password is authenticated in the password check routine R3. If a result of the determination by the remote controller control unit 84 in Step S21 indicates that the password is authenticated in the password check routine R3, the process proceeds to Step S22. If a result of the determination by the remote controller control unit 84 in Step S21 indicates that the password is denied in the password check routine R3, the process proceeds to Step S23. In Step S22, the remote controller control unit 84 restores the control range to the default control range or restores the function to default function. In Step S23, the remote controller control unit 84 indicates or illuminates letters that say “password error” on the liquid crystal panel 81.

(Password Check Routine)

As shown in FIG. 10, in Step S31, the remote controller control unit 84 determines whether or not a password is unset. If a result of the determination by the remote controller control unit 84 in Step S31 indicates that a password is unset, the process proceeds to Step S34. If a result of the determination by the remote controller control unit 84 in Step S31 indicates that a password is already set, the process proceeds to Step S32. In Step S32, the remote controller control unit 84 displays an authentication password input screen on the liquid crystal panel 81. Here, when the user inputs a password, the process proceeds to Step S33. In Step S33, the remote controller control unit 84 determines whether or not the password input in Step S32 matches a preset password. If a result of the determination by the remote controller control unit 84 in Step S33 indicates that the password input in Step S32 matches the preset password, the password is regarded as being authenticated. If a result of the determination by the remote controller control unit 84 in Step S33 indicates that the password input in Step S32 does not match the preset password, the password is regarded as being denied. In Step S34, the remote controller control unit 84 displays a password setting input screen on the liquid crystal panel 81. In Step S35, the user sets a password.

### <Password Change Function>

When the user presses the dehumidifying button while pressing the humidifying button 82e, the remote controller control unit 84 displays a password change screen on the liquid crystal panel 81. Note that, on this password change screen, the user has to enter a current password first, otherwise the user cannot proceed to a new password setting screen.

### <Characteristics of the Air Conditioning System>

(1)

In an air control conditioning system 10 according to this embodiment, if the user performs a button operation for changing the control range/selecting a function, the user can limit the control range or available functions. In addition, the limitation of the control range and available functions are protected by password authentication. Accordingly, in the air conditioning control system 10, for example, the user can allow children, elderly people, and the like and the like to use the air conditioner 1 within a limited temperature setting range. Therefore, in the air conditioning control system 10, the user can prevent children, elderly people, and the like from operating the air conditioner 1 and causing the room to be overcooled or overheated. As a result, in the air conditioning control system 10, the user can prevent children, elderly people, and the like from easily catching a cold and from being charged with unexpected expenses. In addition, in the air conditioning control system 10, the user can limit a temperature setting range in a manner that prevents children, elderly people, and the like from experiencing excessive stress. As a result, in this air conditioning control system 10, the user can prevent: children, elderly people, and the like from easily catching a cold; the user from being charged with unexpected expenses; and children, elderly people, and the like from experiencing excessive stress.

(2)

In the air control conditioning system 10 according to this embodiment, if the user performs a button operation for canceling the control range/restoring default function, the user can cancel the limitation of the control range (restoration of the default control range) or cancel the limitation of available functions (restoration of default function). In addition, cancellation of the limitation of the control range and cancellation of the limitation of available functions are protected by password authentication. Accordingly, the air conditioning control system 10 has a higher security function with respect to the change of the control range and restoration of functions by a third person (for example, a child, elder person, etc.).

(3)

In the air control conditioning system 10 according to this embodiment, the user can set an effective period of the limitation of the control range or available functions. Accordingly, the user can save the time in canceling the limitation of a control range or the limitation of available functions.

### ALTERNATIVE EMBODIMENTS

(A)

In the air conditioning control system 10 according to the above mentioned embodiment, the wireless remote controller is employed as the remote controller 8. However, instead of this, a wired remote controller may be employed.

(B)

In the air conditioning control system 10 according to the above mentioned embodiment, a room air conditioner of separate type is employed as the air conditioner 1. However, instead of this, a ceiling embedded type air conditioner, ceiling hanging type air conditioner, or multi type air conditioner of separate type may be employed. Note that when the air conditioner employed is a multi type air conditioner, it is preferred that the operation limiting function is installed in each of a plurality of remote controllers provided to each indoor unit.

(C)

In the air conditioning control system 10 according to the above mentioned embodiment, the air conditioner provided with the humidifying function and the air supply and exhaust function is employed as the air conditioner 1. However, an air conditioner not provided with these functions or a cooling only air conditioner or the like may be employed.

(D)

In the air conditioning control system 10 according to the above mentioned embodiment, when the control range or available functions are limited, a control signal (remote control code) that corresponds to a range outside of the limited control range is not sent to the input port 102 of the indoor unit 2. However, instead, it may be configured such that information of the control range is sent from the remote controller 8 to the main body control unit 100 of the indoor unit 2 and the main body control unit 100 stores the information of the control range, and when a control signal sent from the remote controller 8 is outside of the control range, the main body control unit 100 determines that the control signal is invalid.

(E)

In the air conditioning control system 10 according to the above mentioned embodiment, a password to limit the control range and a password to cancel the limitation are the same. However, the software may be designed such that a password to limit the control range is different from a password to cancel the limitation.

(F)

In the air conditioning control system 10 according to the above mentioned embodiment, the user can freely set the control range through the operation to limit the control range. However, it may be configured such that the user selects a predetermined control range through the operation to limit a control range.

(G)

In the air conditioning control system 10 according to the above mentioned embodiment, a password is employed as authentication information. However, identification number, image, and biological information (sound, fingerprint, voiceprint, palm print, iris, etc.) may be used as authentication information.

(H)

In the air conditioning control system 10 according to the above mentioned embodiment, the user can set an effective period using days and hours. However, it may be configured such that the user can set an effective period using only hours. In such a case, the user will set a start time and an end time of an effective period within 24 hours. Note that the user may wish that the default control range be applied in a period from the start time to the end time and that the limited control range be applied in a period outside of the aforementioned period. In this case, the remote controller 8 may be designed such that the user first sets a start time and an end time and then the user can select to apply either the default control range or the limited control range in this period. As a matter of course, in this case, one of the control ranges, whichever was not selected, will be applied in a period outside of the set period. In addition, at this time, it may be designed that the user can specify days of the week.

(I)

In the air conditioning control system 10 according to the above mentioned embodiment, the user can set an effective period using days and hours. However, it may be configured such that the user can set an effective period using only hours. In such a case, the user will set the effective period within 24 hours. Note that the user may wish to set a plurality of effective periods of the default control range and apply the limited control range in a period outside of these periods. In this case, the remote controller 8 may be designed such that the user first sets a plurality of effective periods of the default control range and then the user can select to apply either a default control range or the limited control range in these periods. As a matter of course, in this case, one of the control ranges, whichever was not selected, will be applied in a period outside of the set period. In addition, at this time, it may be designed that the user can specify days of the week.

(J)

In the air conditioning control system 10 according to the above mentioned embodiment, the user can set an effective period using days and hours, and the default control range is applied in a period outside of the effective period. However, it may be designed such that the user can limit the default control range to a predetermined control value in a period outside of the effective period.

(K)

In the air conditioning control system 10 according to the above mentioned embodiment, when the user limits a control range, the user has to enter a password. However, it may be configured such that authentication is done as the user simultaneously presses a plurality of specific operation buttons.

### INDUSTRIAL APPLICABILITY

The air conditioning control system according to the present invention is characterized by being capable of preventing: children, elderly people, and the like from easily catching a cold; the householder and the like from being charged with unexpected expenses; and children, elderly people, and the like from experiencing excessive stress. This air conditioning control system is useful as an air conditioner for home use and the like.

1. An air conditioning control system comprising:
an air conditioner;
an operating capacity setting unit configured to set the operating capacity of the air conditioner within a first range;
an operating capacity range changing unit configured to change the first range to a second range which is a range within the first range and narrower than the first range;
a first authentication information inputting unit configured to input a first authentication information; and
an operating capacity range change allowability determining unit configured to determine whether or not to allow a change from the first range to the second range based on the first authentication information.

2. The air conditioning control system according to claim 1, further comprising
a first authentication information setting unit configured to set the first authentication information, wherein
the operating capacity range change allowability determining unit allows a change from the first range to the second range only when the first authentication information set with the first authentication information setting unit matches the first authentication information inputted with the first authentication information inputting unit.

3. The air conditioning control system according to claim 2, further comprising
an information displaying unit,
the operating capacity range change allowability determining unit displaying a second range setting screen on the information displaying unit that enables the second range to be set only when the first authentication information set with the first authentication information setting unit matches the first authentication information inputted with the first authentication information inputting unit.

4. The air conditioning control system according to claim 1, further comprising
an operating capacity range restoring unit configured to change the second range back to the first range.

5. The air conditioning control system according to claim 4, further comprising
an operating capacity range restoration allowability determining unit configured to determine whether or not to allow a change from the second range back to the first range based on second authentication information.

6. The air conditioning control system according to claim 1, further comprising
a second range effective period setting unit configured to set an effective period of the second range.

7. The air conditioning control system according to claim 6, wherein
a plurality of effective periods of the second range are set with the second range effective period setting unit.

8. The air conditioning control system according to claim 6, further comprising
a first operating capacity value limiting unit configured to limit the operating capacity of the first range to a predetermined operating capacity value within the first range in a period outside of an effective period of the second range.

9. The air conditioning control system according to claim 1, further comprising
a 24-hour time limited effective range time inputting unit configured to set a start time and an end time of an effective period of the first range or the second range within a limited period of 24 hours; and
a 24-hour time limited effective range setting unit, wherein
when a start time and an end time of an effective period of the first range are input with the 24-hour time limited effective range time inputting unit, a period from 0 hours to the start time and a period from the end time to 24 hours are set as an effective period of the second range; whereas when a start time and an end time of an effective period of the second range are input with the 24-hour time limited effective range time inputting unit, a period from 0 hours to the start time and a period from the end time to 24 hours are set as an effective period of the first range.

10. The air conditioning control system according to claim 1, further comprising
a 24-hour time limited multiple effective range time inputting unit configured to set a plurality of effective periods of the first range or a plurality of effective periods of the second range within a limited period of 24 hours, and
a 24-hour time limited multiple effective range setting unit wherein
when a plurality of effective periods of the first range are input with the 24-hour time limited multiple effective range time inputting unit, a period outside of the effective periods of the first range is set as an effective period of the second range; whereas when a plurality of effective periods of the second range are input with the 24-hour time limited multiple effective range time inputting unit, a period outside of the effective periods of the second range is set as an effective period of the first range.

11. The air conditioning control system according to claim 9, further comprising
a second operating capacity value limiting unit configured to limit the operating capacity of the first range to a predetermined operating capacity value within the first range.

12. The air conditioning control system according to claim 9, further comprising
a day of the week inputting unit configured to input days of the week to set the effective period.

13. The air conditioning control system according to claim 1, further comprising
an air conditioning control device provided separately from the air conditioner, wherein
the operating capacity setting unit, the operating capacity range changing unit, the authentication information inputting unit, and the operating capacity range change allowability determining unit are disposed in the air conditioning control device.

14. The air conditioning control system according to claim 1, further comprising
an air conditioning control device provided separately from the air conditioner, wherein
the operating capacity setting unit, the operating capacity range changing unit, and the authentication information inputting unit are disposed in the air conditioning control device, and
the operating capacity range change allowability determining unit is disposed in the air conditioner.

15. The air conditioning control system according to claim 13, wherein
the air conditioner and the air conditioning control device are wirelessly connected.

16. An air conditioning control device comprising:
an operating capacity setting unit configured to set the operating capacity of the air conditioner within a first range;
an operating capacity range changing unit configured to change the first range to a second range which is a range within the first range and narrower than the first range;
a first authentication information inputting means capable of inputting unit configured to input a first authentication information; and
an operating capacity range change allowability determining unit configured to determine whether or not to allow a change from the first range to the second range based on the first authentication information.

17. An air conditioning control system comprising:
an air conditioner having a plurality of functions;
a function activation selecting unit configured to select whether or not to activate each of the plurality of functions;
a first authentication information inputting unit configured to input a first authentication information; and
a function selection allowability determining unit configured to determine whether or not to allow the selection based on the first authentication information.

18. An air conditioning control device comprising:
a function activation selecting unit configured to select whether or not to activate each of a plurality of functions of an air conditioner;
a first authentication information inputting unit configured to input a first authentication information; and
a function selection allowability determining unit configured to determine whether or not to allow the selection based on the first authentication information.
